(19) United States
(12) Patent Application Publication
(10) Pub. No.: US 2014/0180687 A1
(43) Pub. Date: Jun. 26, 2014

(54) Method And Apparatus For Automatic Conversion Of Audio Data To Electronic Fields of Text Data

(71) Applicant: Carl O. Kamp, III, Chesterfield, MO (US)

(72) Inventor: Carl O. Kamp, III, Chesterfield, MO (US)

(21) Appl. No.: 14/041,959

(22) Filed: Sep. 30, 2013

Related U.S. Application Data
(60) Provisional application No. 61/708,351, filed on Oct. 1, 2012.

(51) Int. Cl. G10L 15/26

(52) U.S. Cl. CPC G10L 15/26
USPC 704/235

(57) ABSTRACT

A computer system capable of administering a search engine program with a marketing component, which includes at least one client device operatively connected to a host server through a communication network to communicate data between the client device and the host server. A compilation program receives data in audio format for conversion into a text format. The converted data is combined with a second source of data for storage and display on clients devices.

### CROSS-REFERENCE TO RELATED COMPILATIONS

This Non-Provisional application claims priority to U.S. Provisional Application Ser. No. 61/708,351 filed Oct. 1, 2012, and which is incorporated herein by reference.

### STATEMENT REGARDING FEDERALLY SPONSORED RESEARCH

Not Applicable.

### BACKGROUND

A growing population of senior citizens is making the home and hospice health care industry an increasingly important option in today's medical system. For some seniors, home health care can be a less expensive and provide a better quality of life than a nursing home or assisted living.

One of the biggest challenges with home and hospice care is maintaining proper communication and documentation between the staff in the field, the supervisors at the main office, and any other necessary parties. Typically, staff in the field prefers to prepare patient reports by dictation, which is more convenient and time efficient to prepare than written reports or manual entry into a computer. However, supervisors and other parties prefer the reports to be in a readable text format, which can be reviewed quicker than listening to audio reports. In addition, data in a text format are easier to transfer from one party to another. There would be numerous benefits to allowing staff in the field to prepare reports by dictation and converting those audio reports into electronic fields of text format. For example, converting audio data to electronic fields of text data allows for searching, linking, pairing, or combining with other data, such as electronically stored data in a database or data from a mobile device. This would allow for faster and more detailed data and reports as well as provide for better supervision of care.

Unfortunately, manually converting dictation to a text format is a time consuming, expensive, and labor intensive process. Generally, any benefits from the conversion of the audio data to text data are outweighed by the cost and the time lag between the initial audio data and the conversion to the text data.

Therefore, what is needed is a cost-efficient automated system and method to convert audio reports to electronic fields of text format.

### DESCRIPTION OF THE DRAWINGS

In the accompanying drawings which form part of the specification:

FIG. 1 is a block diagram of a system for a computer system for administering a compilation program;

FIG. 2 is a flowchart illustrating an embodiment of the operation of a compilation program;

FIG. 3 is a flowchart illustrating the process of fielding input via IVR in the compilation program of FIG. 2;

FIG. 4 is a flowchart illustrating the process of processing audio data in the compilation program of FIG. 2;

FIG. 5 is a flowchart illustrating the process of record matching in the compilation of FIG. 2;

FIG. 6 is a flowchart illustrating the process of reporting and storage in the compilation of FIG. 2;

FIG. 7 is a is a sample data entry appearing on the display of the client device; and

FIG. 8 is a sample report appearing on the display of the client device.

Corresponding reference numerals indicate corresponding parts throughout the several figures of the drawings.

### DETAILED DESCRIPTION

The following detailed description illustrates the claimed invention by way of example and not by way of limitation. The description clearly enables one skilled in the art to make and use the disclosure, describes several embodiments, adaptations, variations, alternatives, and uses of the disclosure, including what is presently believed to be the best mode of carrying out the claimed invention. Additionally, it is to be understood that the disclosure is not limited in its compilation to the details of construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting.

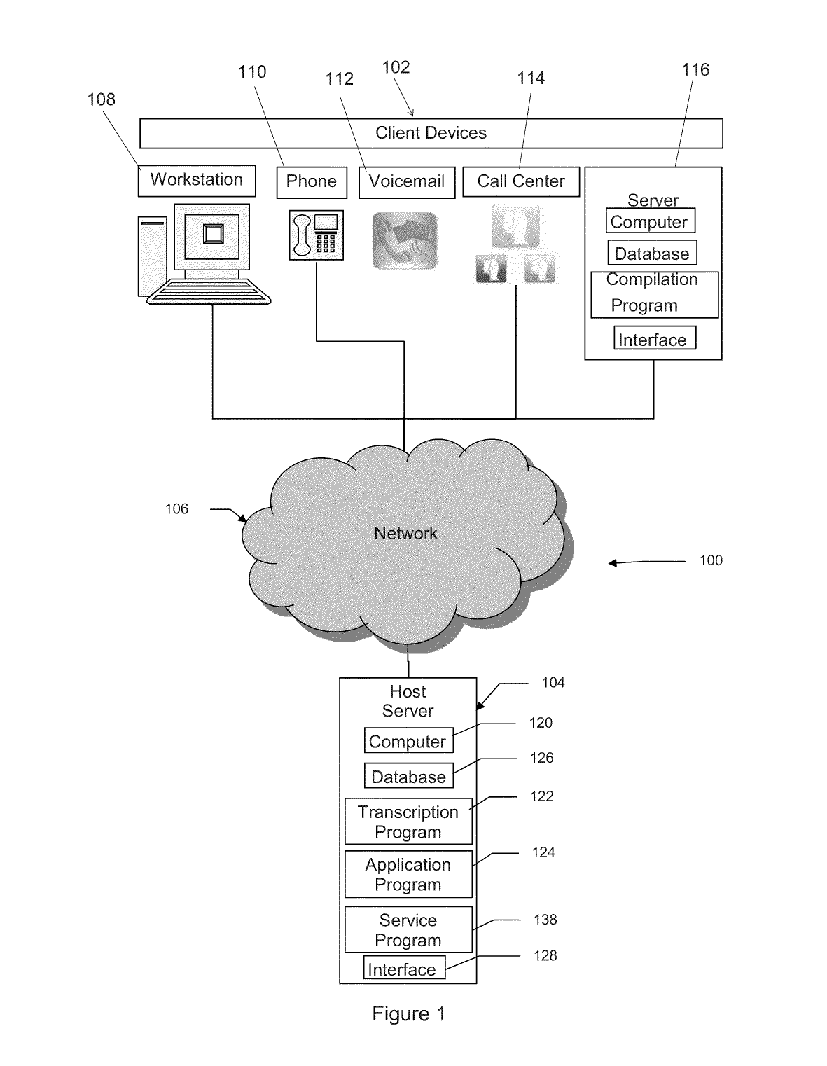

As shown in FIG. 1, an embodiment of the present invention, generally referred to as a computer system 100, includes at least one client device 102 operatively connected to at least one host server 104 through a communication network 106, or directly, to communicate data between the client devices 102 and the host server 104. The computer system 100 is capable of administering a compilation program 122 to compile data inputs from the client devices 102 so that users can submit or retrieve data from the host server 104 in either an audio format or a text format.

In the embodiment of FIG. 1, the network 106 is the Internet, which uses a suitable communications protocol, such as HyperText Transfer Protocol (HTTPS), to communicate data between the client devices 102 and the host server 104. However, the network 106 can be any network that allows an exchange of data between the client devices 102 and the host server 104, such as a LAN or WAN (Wide Area Network). In addition, any suitable type of communications protocol can be used, such as FTP (File Transfer Protocol), SNMP (Simple Network Management Protocol), TELNET (Telephone Network), and the like. Alternatively, the client device 102 can be directly connected to the host server 104 for communication of data.

The host server 104 preferably comprises a computer system 120, having a processor, memory, and a mass storage device, which is capable of running the compilation program 122. A database 126 is stored on the mass storage device, which can contain electronic data, such as outside database files or other voice to database files. Also, the host server 104 is appropriately equipped with a network interfacing device 128 for communicating data with the network 106, such as a dial-up modem, a cable modem, a satellite connection, a DSL connection, a LAN, or the like. If necessary to accommodate large amounts of information or run numerous compilations, alternate embodiments of the host server 104 can comprise multiple computer systems, multiple databases, or any combination thereof.

In the embodiment of FIG. 1, the client devices 102 include a computer workstation 108, a telephone 110, a voicemail system 112, a call center system 114, and a server 116. However, the client devices 102 can include any electrical or electronic device capable of communicating with the host server 116 either directly or through the network 106, such as, for example, a personal digital assistant (PDA), mobile electronic device, cellular phone, or a television operating with a cable or satellite television interactive system.

Users access the compilation program 122 on the host server 104 through the selected client devices 102. Generally, the compilation program 122 allows users to submit or retrieve electronically stored data from the database 126 in either an audio format or a text format, depending on the type of client device 102 selected and the desired format. For example, a user can interface with the telephone 110, the call center 112, or the voicemail system 114 to submit or receive data in audio format from the compilation program 122. Alternatively, the user can interface the workstation 108 to submit or receive data in text format or audio format.

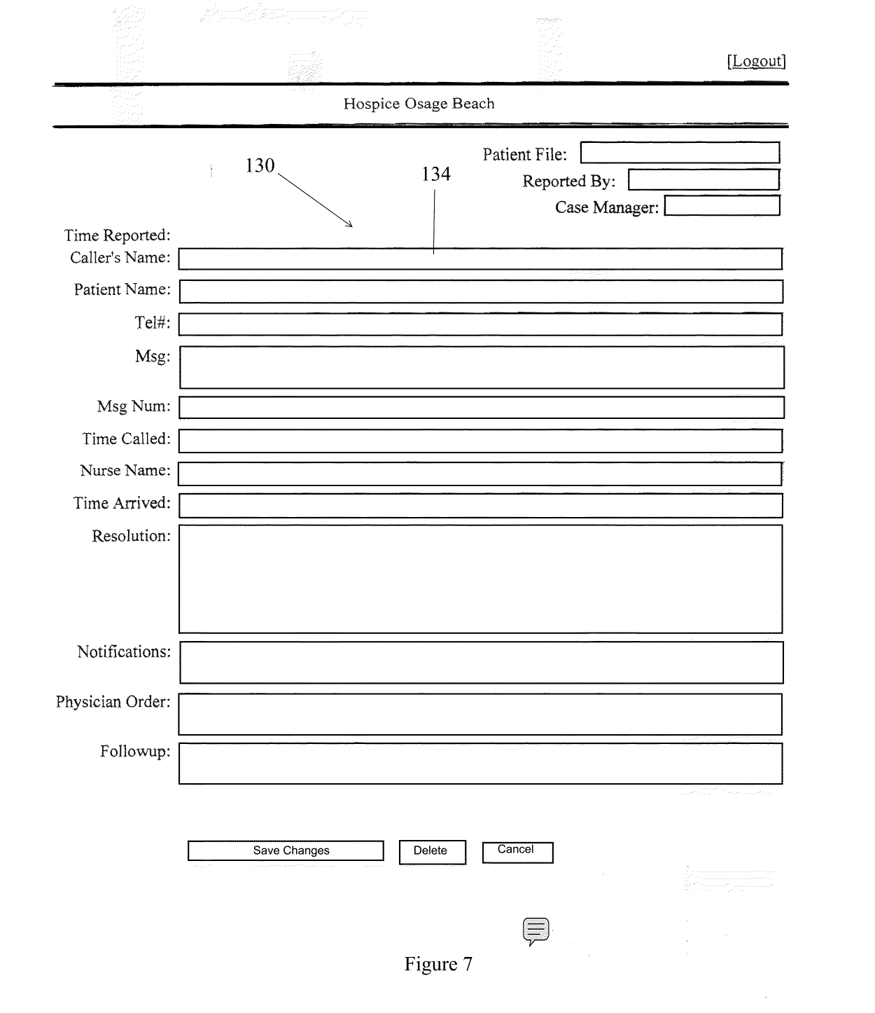

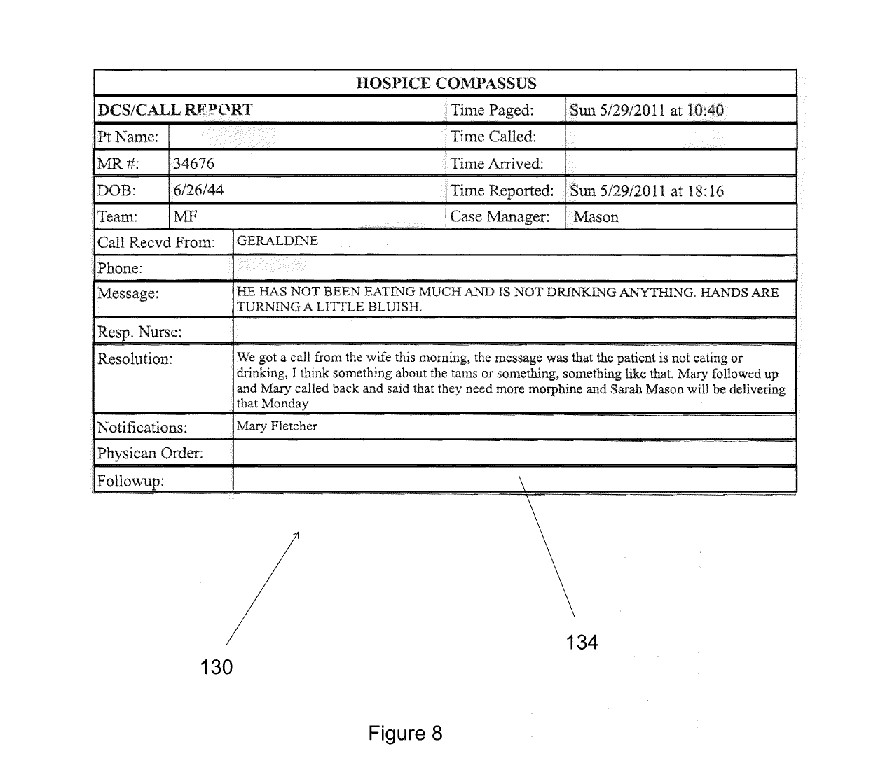

The computer workstation 108 includes a processor, memory, a mass storage device, a display device, and an input device, such as a keyboard, that is capable of running a network interfacing program, such as web browser software available, for example, from Netscape® Corporation, Apple® Corporation, or from Microsoft® Corporation. The computer 108 is appropriately equipped with a network interfacing device for communicating data with the network 106, such as a dial-up modem, a cable modem, a satellite connection, a DSL (Digital Subscriber Line) connection, a LAN (Local Area Network), or the like. The computer workstation 108, can be used for entry of data in text format or audio format via the keyboard, or other suitable input interface such as a mouse, microphone, touch screen, and the like. For example, the compilation program 122 generates a web page, such as data entry pages 130 (FIG. 7-8), that transmits through the network 106 and displays on the display 110. In the preferred embodiment, the data page 132 includes a plurality of data fields 134. The user interacts with the compilation program 122 by entering data with the input device 112. By selecting one of these options, the compilation program 122 generates additional web pages and interacts with the database 126 and the client device 102 in order to communicate data. The content and operation of such websites are managed by the server device, such as host server 104, which is operatively connected to the network 106.

The telephone 110 can be any conventional telecommunication device, such as landline or cellular devices, that connect to the network 106 in any suitable manner, including, but not limited to voice-over-internet-protocol (VOIP) and digital telephony. The voicemail system 112 can be any system of receiving, storing, and conveying telecommunications voice messages. The call center system 114 can be any centralized office used for the purpose of receiving or transmitting a large volume of audio data by telephone.

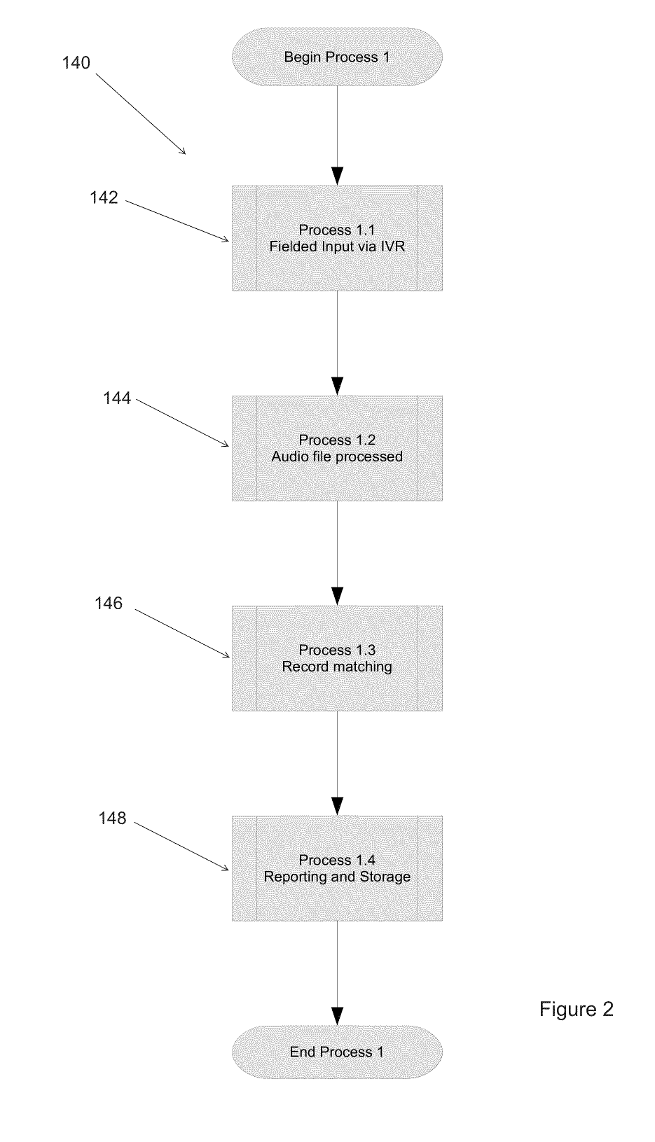

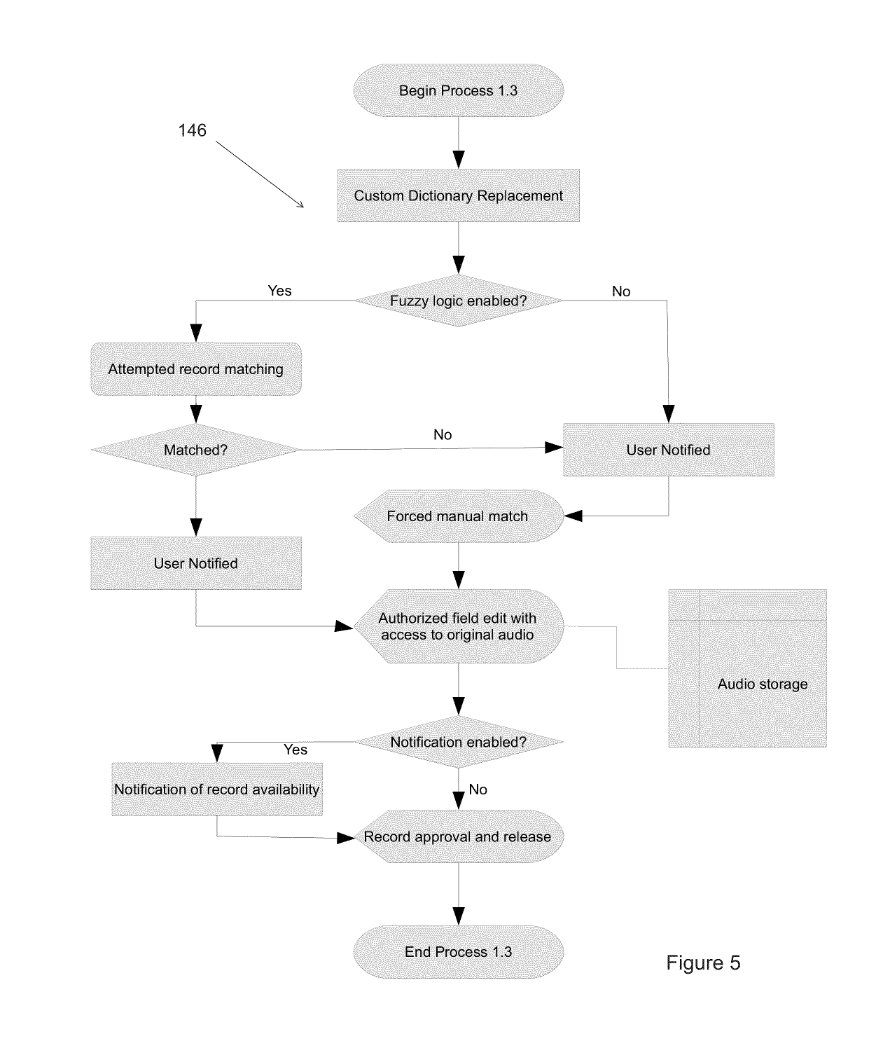

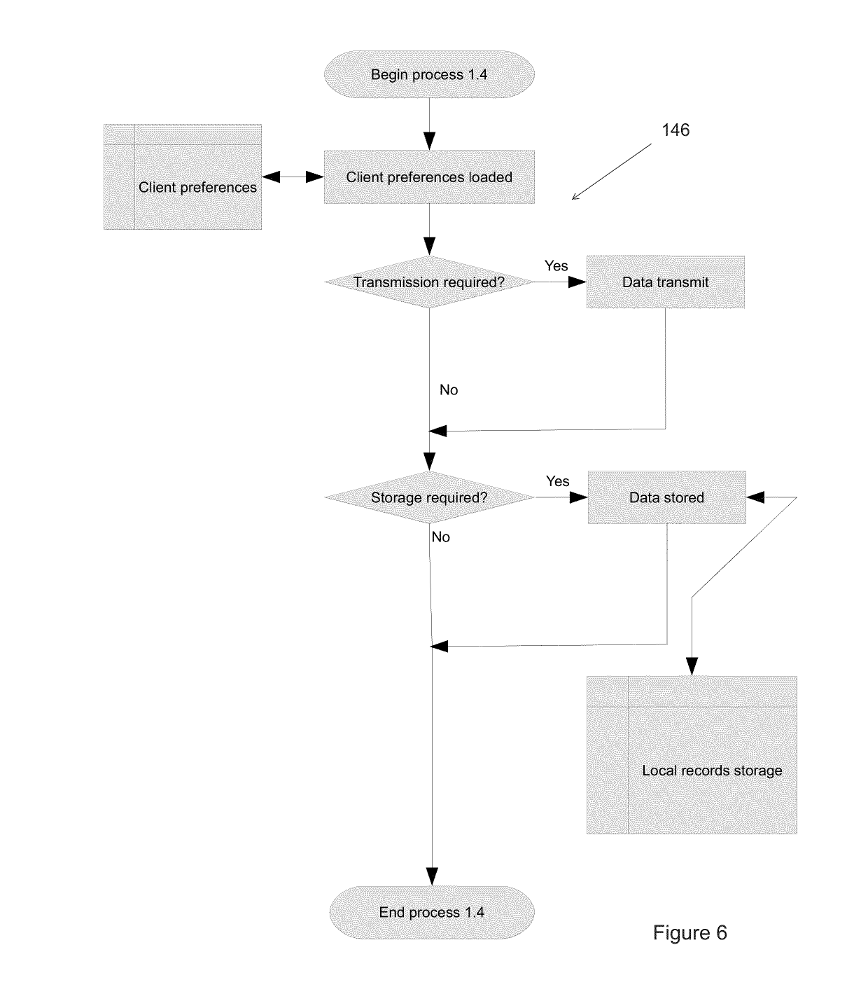

As shown in FIGS. 2-6, the compilation program 122 includes a plurality of process modules 140 for compiling data, including Process 1.1 fielded input via interactive voice recognition (IVR) 142, Process 1.2 audio file processed 144, Process 1.3 record matching 146, and Process 1.4 reporting and storage 148.

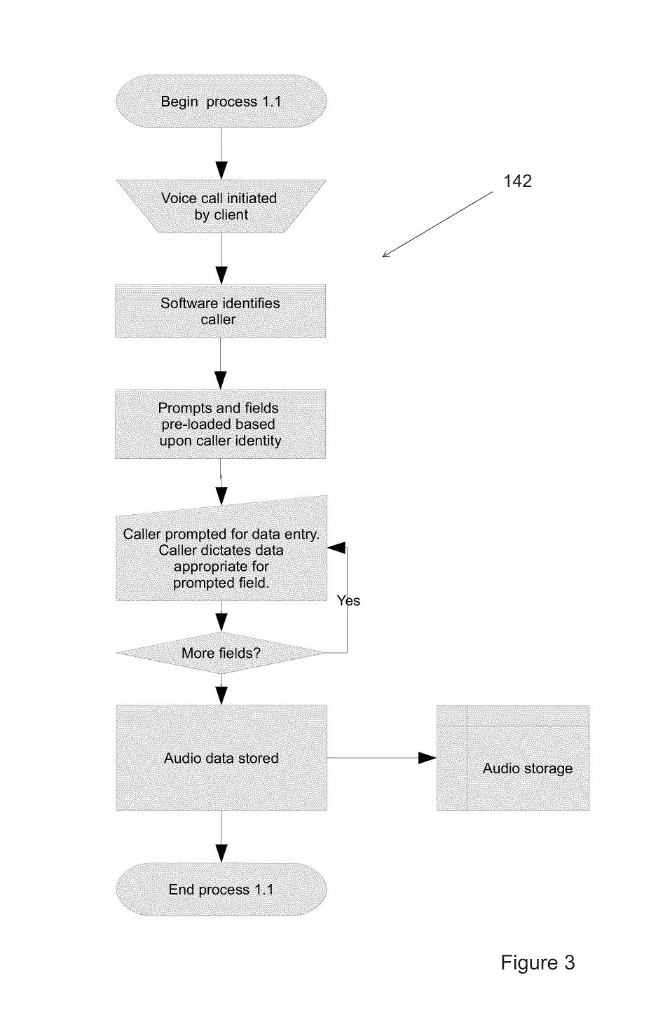

The first module Process 1.1 fielded input via IVR 142 is a process for receiving and storing audio data in the database 126 of the host server 104. (FIG. 3). A user interfaces one of the client devices 102, such as the telephone 110, and initiates a call to the host server 104. The first module 142 identifies the caller, such as with caller identification technology. Based on the identification of the caller, the first module 142 plays a plurality audio prompts to the caller to submit data in audio format after each prompt, which have been previously stored in the database 126. The audio prompts can be customized to correspond with the identification of each caller. The audio data submitted by the caller after each prompt is stored on the database 126 as an audio file.

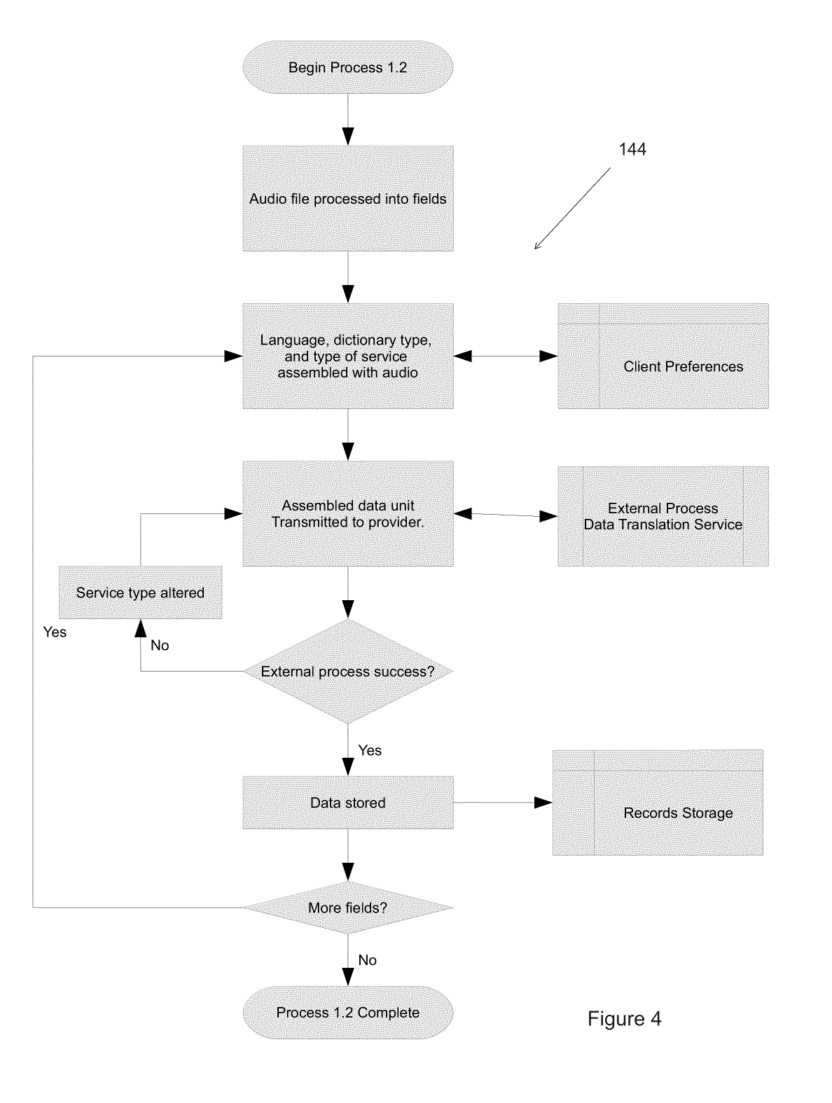

The second module Process 1.2 audio file processed 144 is a process for converting the data stored in the database in audio format into fields of text format. As shown in FIG. 4, the second module 144 processes the audio file from the first module 142 into multiple files, or fields, corresponding to the caller's audio response to each prompt. A user designates a plurality of criteria for the second module 142, such as language, dictionary type, and types of service to be assembled with each audio file. The second module 142 assembles the criteria and the audio files into a data unit for transfer to a data translation service, which converts the audio files of the data unit into fields of text format. The converted data unit is transferred back to the second module 142, which determines if the conversion was successful. If successful, the data unit is stored on the database 126. If not successful, the data unit is transferred to the data translation service for further conversion. The data translation service can perform the conversion in any suitable manner, such as by computer, by persons, or a combination.

The third module Process 1.3 record matching 144, is a process for pairing the data units from the second module 144 with the corresponding audio files from the second module 144 and any other corresponding data, such as data stored on the database 126 or data entered in text format through one of the client devices 102. The third module 144 edits the data unit as needed using a customer specific search and replace dictionary to enhance the accuracy of the of the audio format to text format conversion. The content of the dictionary can be modified to correspond to the customer's specific criteria, such as profession or activity. The data unit as edited can be displayed to the user for review. The third module 144 matches the corresponding data units, audio files, and other data. If unsuccessful, the user is notified and required to perform a manual match. If successful, the user is provided with an opportunity to edit the matched files, or final record and enter an optional electronic signature. The final record is stored on the database 126 and a notification of record availability is sent to the user through the client device 102.

The fourth module Process 1.4 reporting and storage 146 is a process for transmitting and storing the final records. The user interfaces one of the client devices 102, such as the computer workstation 108, to request a final record from the database 126, such as with a request webpage. The fourth module 146 includes preferences corresponding to the user, such as authentication information. The final record is communicated from the database 126 to the computer workstation 108, preferably in a secure manner, such as with encryption.

The final records can be displayed in any manner desired. For example, each field of the report can have a designated data type, and each report can be routed to a different transcription service and/or software system on a per field per-account basis. Such software systems may be external medical record systems, customer relationship management programs, or sales reporting systems.

Alternatively, a variety of custom reports can be viewed with color-coded backgrounds to indicate the progress of database creation, reports, and necessary follow-up actions. Notifications can be generated in a variety of ways to notify interested personnel that a report or database record has been created.

The computer system 100 can be used in conjunction with any type of data for use with almost any industry. In addition, it facilitates communication between employees and vendors.

Changes can be made in the above constructions without departing from the scope of the disclosure, it is intended that all matter contained in the above description or shown in the accompanying drawings shall be interpreted as illustrative and not in a limiting sense.

What is claimed is:

1. A method of administering a compilation program through a computer system having at least one server, at least one client device, and a communication network operatively and electrically connecting the client device to the at least one server, the method comprising the steps of:
providing a compilation program on the at least one server without transmitting advertisements to the at least one client device;
entering data in an audio format or a text format into the at least one client device by the user;
transmitting the data to the at least one server;
converting the data in an audio format into a text format;
combining the data with a second source of data into a final record;
storing a final record; and
displaying the final record on at least one client device.

2. A system comprising any feature described, either individually or in combination with any feature, in any configuration for the system described in the specification and figures for a method of administering a compilation program.
